(19) United States
(12) Patent Application Publication
(10) Pub. No.: US 2013/0048337 A1
(43) Pub. Date: Feb. 28, 2013

(54) CARBON-BASED SUBSTRATES WITH ORGANOMETALLIC FILLERS

(71) Applicants: JESSICA HENDERSON BROWN HEMOND, MIFFLINTOWN, PA (US); ROBERT DANIEL HILTY, HARRISBURG, PA (US)

(72) Inventors: JESSICA HENDERSON BROWN HEMOND, MIFFLINTOWN, PA (US); ROBERT DANIEL HILTY, HARRISBURG, PA (US)

(73) Assignee: TYCO ELECTRONICS CORPORATION, BERWYN, PA (US)

(21) Appl. No.: 13/216,943

(22) Filed: Aug. 24, 2011

(51) Int. Cl. H01B 7/00; H01R 43/00; H01B 5/00; B82Y 99/00

(52) U.S. Cl. 174/113 C; 174/126.2; 29/825; 977/932; 977/788

(57) ABSTRACT

A cable includes a jacket surrounding a core and a carbon-based substrate (CBS) conductor in the core. The CBS conductor includes a CBS network and an organometallic filler, wherein the organometallic filler combines with the CBS network to form a composite conductor having a higher conductivity than the CBS network. Optionally, the CBS network may include carbon nanotube (CNT) fibers with the organometallic fillers being disposed within the CNT fibers. The organometallic fillers may include at least one of palladium glycolate, glycolic acid, glyoxyllic acid or methanol. A method for manufacturing a carbon-based substrate (CBS) conductor, such as for a cable, includes providing a CBS network of CBS fibers forming a framework, introducing an organometallic compound, and reacting the CBS network with the organometallic compound to form a composite conductor. The method may include immersing the CBS network in an organometallic bath having organometallic particles in a solvent.

### BACKGROUND OF THE INVENTION

The subject matter herein relates generally to carbon-based substrate (CBS) conductors, cables and other electrical components using CBS conductors and methods of manufacturing CBS conductors, cable or other electrical components using CBS conductors.

CBSs may include carbon nanotubes (CNTs), graphene or other carbon-based networks as the substrate. CBSs have use in a wide range of applications. Due to the electrical conductivity exhibited by CBSs, CBSs have application in electrical systems, such as use as electrical conductors of cables, wires or other conductors, as electromagnetic interference (EMI) shielding for cables or other types of electronic components, and other applications. Due to the relative light weight of CBSs, as compared to traditional metal components, CBSs have application in aeronautical application where weight is a significant design factor.

CBSs for use as electrical conductors are not without disadvantages. For instance, for some applications, the electrical conductivity of the CBS network is inadequate. A need remains for a CBS network that exhibits good electrical characteristics.

### BRIEF DESCRIPTION OF THE INVENTION

In one embodiment, a cable is provided having a jacket surrounding a core and a carbon-based substrate (CBS) conductor in the core. The CBS conductor includes a CBS network and an organometallic filler, wherein the organometallic filler combines with the CBS network to form a composite conductor having a higher conductivity than the CBS network. Optionally, the CBS network may include carbon nanotube (CNT) fibers with the organometallic fillers being disposed between the CNT fibers. The organometallic fillers may include at least one of palladium glycolate, glycolic acid, glyoxyllic acid or methanol. The CBS network may be a yarn, a sheet, or a tape. Optionally, the organometallic filler may be applied to the CBS network as a solution that is decomposed under heat to create the composite conductor. The CBS network may be bathed in an organometallic bath to react the organometallic filler with the CBS network. The organometallic filler may be introduced as an organometallic bath having a solvent and organometallic particles in solution, where the solvent is heated to remove the solvent from the composite conductor leaving the reacted organometallic particles on the CBS network. The CBS network and the organometallic fillers may be densified to create the composite conductor.

Optionally, the cable may include a plurality of the CBS conductors twisted along a length of the cable to form a central conductor of the cable. The CBS conductor may surround the core and provide EMI shielding for the core. The cable may be a coaxial cable having an insulator and a second CBS conductor in the core with the insulator surrounding the CBS conductor, the second CBS conductor surrounding the insulator and the jacket surrounding the second CBS conductor. The second CBS conductor may provide EMI shielding for the other CBS conductor, which may be configured to convey electrical signals between a first end and a second end of the cable.

In another embodiment, a method for manufacturing a carbon-based substrate (CBS) conductor is provided that includes providing a CBS network of CBS fibers forming a framework, introducing an organometallic compound, and reacting the CBS network with the organometallic compound to form a composite conductor. The method may include immersing the CBS network in an organometallic bath having organometallic particles in a solvent. The reacting may include heating the composite conductor to remove the solvent leaving behind the converted organometallic particles. The method may include annealing the composite conductor and/or densifying the composite conductor by heating and cooling the composite conductor. The method may include extracting CBS fibers from a CBS array to form the framework having a shape of one of a yarn, a tape or a sheet. The method may include forming the composite conductor into a cable during a cable forming process.

### BRIEF DESCRIPTION OF THE DRAWINGS

FIG. 1 is a cross-sectional view of a cable formed in accordance with an exemplary embodiment.

FIG. 2 is a cross-sectional view of a cable formed in accordance with an exemplary embodiment.

FIG. 3 illustrates a cable extending between a first and a second end.

FIG. 4 is an enlarged view of a portion of a carbon-based substrate (CBS) conductor formed in accordance with an exemplary embodiment.

FIG. 5 illustrates a system for manufacturing a CBS conductor in accordance with an exemplary embodiment.

FIG. 6 is a flow chart showing a method of manufacturing a cable in accordance with an exemplary embodiment.

FIG. 7 illustrates an electrical component that incorporates a CBS conductor.

### DETAILED DESCRIPTION OF THE INVENTION

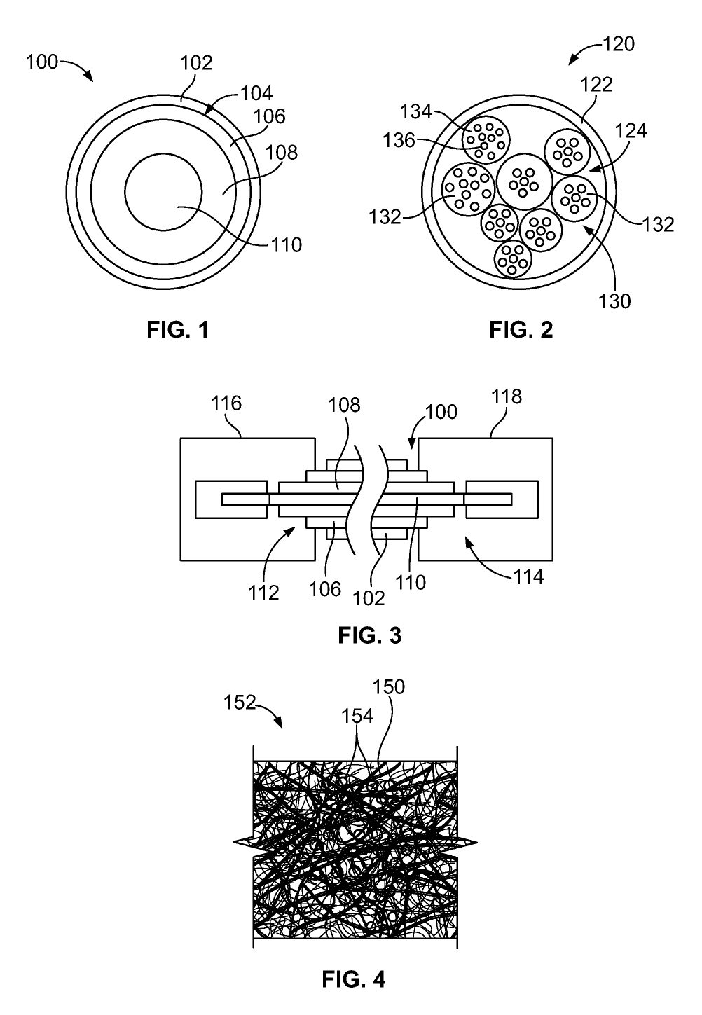

FIG. 1 is a cross-sectional view of a cable 100 formed in accordance with an exemplary embodiment. The cable 100 includes a jacket 102 defining a core 104. An EMI shield 106 is in the core 104 and is surrounded by the jacket 102. An insulator 108 is in the core 104 and is surrounded by the EMI shield 106. A center conductor 110 is in the core 104 and is surrounded by the insulator 108. The insulator 108 electrically isolates the center conductor 110 from the EMI shield 106. The insulator 108 is manufactured from a dielectric material. Optionally, the insulator 108 may be a shrink tube that is heat shrinkable. The jacket 102 is manufactured from a dielectric material. Optionally, the jacket 102 may be a shrink tube that is heat shrinkable. Optionally, the cable 100 may include a drain or ground wire.

The EMI shield 106 and the center conductor 110 are electrically conductive. The cable 100 defines a coaxial cable having the center conductor 110 and an outer conductor defined by the EMI shield 106 extending along a common axis along the length of the cable 100. The cable 100 may be another type of cable, such as a twin-axial cable, a quad-axial cable, an unshielded cable, and the like. The center conductor 110 is configured to convey electrical signals between a first end 112 (shown in FIG. 3) and a second end 114 (shown in FIG. 3) of the cable 100. In an exemplary embodiment, the center conductor 110 is configured to convey data signals. Alternatively, the center conductor 110 may convey power between the first and second ends 112, 114. In other alternative embodiments, the cable 100 may include more than one center conductors that define different electrical paths to convey different electrical signals.

In an exemplary embodiment, the center conductor 110 and the EMI shield 106 are manufactured from a carbon-based substrate (CBS), such as carbon nanotubes (CNTs), graphene, a graphite oxide structure, and the like. Alternatively, the center conductor 110 and the EMI shield 106 are manufactured from another nano-substrate, such as a ceramic nanowire, such as a boron nitride substrate. The CBS-based network may be modified to create other types of electronic components such as a passive dielectric or insulating component. The CBS-based network may be modified to make other compounded/composite surfaces.

The center conductor 110 defines a CBS conductor, and may be referred to hereinafter as a CBS conductor 110. Optionally, the center conductor 110 may include one or more strands of CBS conductors that are twisted together during a cable forming process. The EMI shield 106 defines a CBS conductor, and may be referred to hereinafter as a CBS conductor 106. In an alternative embodiment, only the center conductor 110 is manufactured from a CBS network. In another alternative embodiment, only the EMI shield 106 is manufactured from a CBS network.

In an exemplary embodiment, each CBS conductor 106, 110 is manufactured from a CBS network that is combined with organometallic fillers to form a composite conductor. The organometallic fillers may include compounds containing metal-element bonds that are between ionic and covalent in character. The organometallic fillers may at least partially permeate through, or be infused into, the CBS network and/or the individual fibers or yarns, or alternatively, may be a coating surrounding an outer surface of the CBS network. The CBS network may be a CNT network, a graphene network or another carbon-based network. In an exemplary embodiment, the organometallic fillers are organopalladium compounds, such as palladium glycolate. Other types of compounds or fillers may be used in alternative embodiments. The organometallic fillers may include glycolic acid, glyoxyllic acid, methanol, and the like. The type of base metallic compound used for the organometallic compound is selected to enhance certain characteristics of the CBS network, such as the electrical characteristics of the CBS network.

In an exemplary embodiment, the organometallic fillers are applied by bathing the CBS network in an organometallic bath that includes a solvent and the organometallic particles in the solution. The composite conductor is then processed to remove the solvent and/or react the organometallic with the CBS network. For example, the composite conductor may be subjected to heating, cooling, annealing, densifying, thickening, winding, plying, braiding, functionalizing and the like. The organometallics may be applied by other processes in alternative embodiments, such as physical vapor deposition, chemical vapor deposition, dip coating, or other processes to apply the organometallics to the CBS network.

FIG. 2 is a cross-sectional view of another cable 120 formed in accordance with an exemplary embodiment. The cable 120 includes a jacket 122 defining a core 124. A center conductor 130 is provided in the core 124. The center conductor 130 includes a plurality of strands 132 of CBS conductors that are twisted together during a cable forming process to form the center conductor 130. Any number of strands 132 may be provided.

In an exemplary embodiment, each strand 132 is a separate CBS conductor manufactured from a CBS network 134 that is combined with organometallic fillers 136. The organometallic fillers 136 may extend or permeate entirely through the CBS network 134 such that the organometallic fillers 136 are between the fibers of the CBS network. The organometallic fillers may be both a coating between individual fibers or yarns in a network or braid, and penetrate the fibers or yarns that makes up the network or braid.

FIG. 3 illustrates the cable 100 extending between the first and second ends 112, 114. The cable 100 may have any length defined between the first and second ends 112, 114. The first end 112 is terminated to a first electrical component 116. The second end 114 is terminated to a second electrical component 118.

The first and second electrical components 116, 118 are represented schematically in FIG. 3. The first and second electrical components 116, 118 may be any type of electrical component. Optionally, the first electrical component 116 may be different than the second electrical component 118. The electrical components 116, 118 may be electrical contacts, electrical connectors, circuit boards, or other types of electrical components. The center conductor 110 and/or EMI shield 106 may be electrically connected to the electrical component 116, 118. The center conductor 110 and/or EMI shield 106 are configured to electrically connect the first and second electrical components 116, 118.

In an exemplary embodiment, the CBS network of the CBS conductor is conductive and is configured to convey electrical signals between the first and second electrical components 116, 118. The organometallic fillers may enhance the electrical properties of the center conductor 110 and/or EMI shield 106. For example, the conductivity of the CBS-based center conductor 110 and/or EMI shield 106 may be increased by selecting an organometallic material having a high conductivity.

FIG. 4 is an enlarged view of a portion of the CBS conductor 110 formed in accordance with an exemplary embodiment. The CBS conductor 110 includes a plurality of CBS fibers 150, such as CNT fibers, that are arranged to form a framework 152 that defines the CBS network. Organometallic fillers 154 are applied to the framework 152 to enhance the characteristics of the CBS structure. Optionally, the CBS network may be placed into an organometallic bath for wetting the CBS network. All or portions of the CBS network may be wetted such that the organometallic fillers 154 penetrate or saturate the framework 152. The amount of wetting or penetration of the organometallic fillers 154 may be varied by controlling the amount of time and/or the concentration of the organometallic fillers the CBS network is subjected to during the manufacturing process. The electrical characteristic enhancement may be tuned by controlling the concentration and/or time of exposure in the organometallic bath.

In an exemplary embodiment, the framework 152 may be pulled or drawn from a CBS array or CBS source, such as by using a spinning technique. The framework 152 may be formed into a yarn or wire. The framework 152 may be a braided yarn or a mesh. Alternatively, the framework 152 may be formed into a tape. Alternatively, the framework 152 may be formed into a sheet. The wire, tape or sheet may have any length depending on the particular application. A wire is defined as having a width that is less than approximately two times a thickness of the framework 152. A tape is defined as having a width that is greater than approximately two times the thickness of the framework 152 and having a width that is less than approximately ten times the thickness of the framework 152. A sheet is defined as a framework having a width that is greater than approximately ten times the thickness of the framework 152. The framework 152 may have different shapes depending on the particular application.

The wires or yarns may be used, for example, to define the strands of the center conductor 110 (shown in FIG. 1). The tapes may be used, for example, to form the EMI shield 106 (shown in FIG. 1), wherein the framework 152 may be wrapped around the internal components of the cable 100 such that the opposite edges of the framework 152 touch one another or overlap one another. In other embodiments, the tape may be wrapped in a helical manner around the insulator and center conductor 108, 110 to form an EMI shield. In other alternative embodiments, the tapes may be used to form wires or conductors of a cable, such as by drawing the tape during a cable forming process. The drawing of the tape may occur either pre or post processing to infuse the organometallic fillers 154. The sheet may be used, for example, as an EMI shield that covers an electrical component, such as a housing of a connector to provide EMI shielding for the connector. The framework 152 may have any other shape suitable for the particular application capable of being formed from a CBS structure.

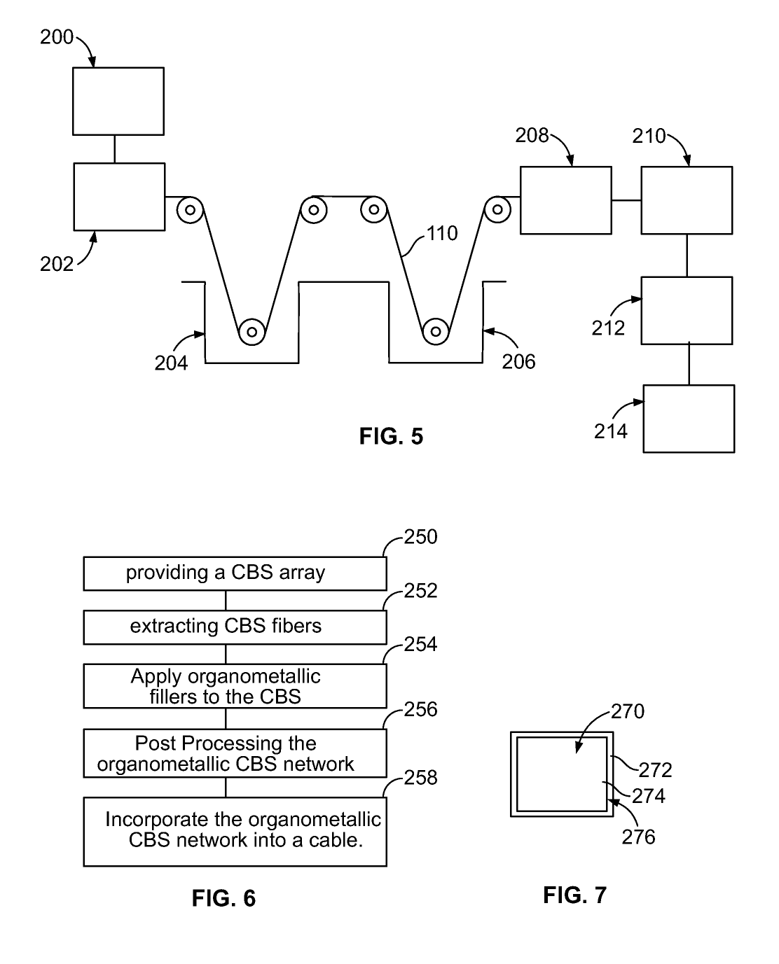

FIG. 5 illustrates a system for manufacturing a CBS conductor, such as the CBS conductor 110, in accordance with an exemplary embodiment. A CBS array 200 is provided as a source of carbon fibers, such as carbon nanotubes or carbon sheets. A drawing module 202 is provided. A solvent bath 204 is provided. An organometallic bath 206 is provided. A densification module 208 is provided. A post-processing module 210 is provided. A cable forming module 212 is provided. A storage module 214 is provided. Other modules may be provided in alternative embodiments.

During manufacture, CBS fibers are pulled or otherwise extracted from the CBS array 200 by the drawing module 202 to make a framework or CBS network. The CBS network may be taken in the form of a wire or yarn, a tape, a sheet and the like. The CBS network is bathed in the solvent bath 204. The CBS network is bathed in the organometallic bath 206. Optionally, the CBS network is bathed in the solvent bath 204 prior to the organometallic bath 206. Alternatively, the CBS network is bathed in the organometallic bath 206 prior to the solvent bath 204. In other alternative embodiments, the CBS network is not bathed in the solvent bath 204, but rather is only bathed in the organometallic bath 206. The solvent bath 204 may include non-organometallic materials, such as metal particles, that are coated or infused into the CBS network to enhance the characteristics of the composite conductor. The composite conductor, with the CBS network, the non-organometallic particles and/or the organometallic fillers, is then directed to the densification module 208. The CBS network is densified, such as by spinning or otherwise densifying the CBS network. The CBS conductor is directed to the post-processing module 210. At the post-processing module 204 the CBS conductor may be subjected to heating, cooling, winding, plying, braiding, shrinking, twisting, doping, densification, pressing, forming or other processes to affect the interaction between the CBS fibers and the organometallic fillers and/or the non-organometallic fillers and/or to define a shape of the CBS conductor.

The CBS conductor is directed to the cable forming module 212 to form a cable, such as the cable 100 (shown in FIG. 1). At the cable forming module 212, one or more of the CBS conductors are used to form the cable 100. For example, one or more CBS conductors in tape or sheet form may be wrapped around the center conductor to form an outer conductor or EMI shield. After the cable is formed, the cable may be stored at the storage module 214.

In alternative embodiments, rather than using the CBS conductors to form cables, the CBS conductors may be used to form other electrical components, such as an electrical connector, a processor, a circuit board, or another electrical component. The CBS conductor may be used as part of a signal conductor or alternatively may be part of an EMI shield or another part of an electrical component.

FIG. 6 is a flow chart showing a method of manufacturing a cable in accordance with an exemplary embodiment. The method includes providing 250 a CBS array as a source of fibers. The method includes extracting 252 CBS fibers from the CBS array to form a framework. The framework may be formed in any shape, such as a wire or yarn, a tape, a sheet or another shape. The method includes applying 254 organometallic fillers to the CBS network or framework, such as by bathing the CBS network in an organometallic bath or by another process.

The method includes post-processing 256 the organometallic CBS network. For example, the post processing may include heating, cooling, winding, plying, braiding, shrinking, twisting, doping, densifying, pressing, forming or performing other processes to affect the interaction between the CBS fibers and the organometallic fillers and/or to define a shape of the CBS conductor. In an exemplary embodiment, the organometallic includes a palladium compound, where the palladium compound is heated to react and/or convert the palladium with the CBS network.

The method includes incorporating 258 the organometallic CBS network into a cable. For example, the organometallic CBS network may be presented to a cable forming machine that pulls the organometallic CBS network into a cable form within a jacket.

The organometallic CBS network may be used in other types of electrical systems other than a cable, such as an electrical connector, a microprocessor, or another type of electrical component. Any application suitable for use with CBSs may utilize the organometallic CBS conductor. The addition of organometallics with the CBS network enhances the characteristics of the CBS network, such as electrically by increasing the conductivity of the CBS network.

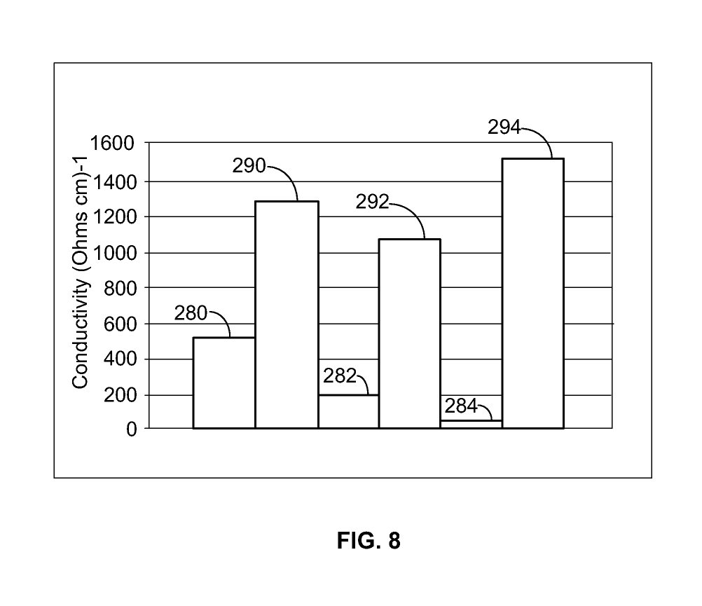

FIG. 7 illustrates an electrical component 270 that incorporates a CBS conductor 272. In the illustrated embodiment, the CBS conductor 272 is used as an EMI shield for electrical component 270. For example, the CBS conductor 272 may be a sheet or tape wrapped around an exterior of the electrical component 270. The electrical component 270 may be an electrical connector having a housing 274 with an outer surface 276. The CBS conductor 272 may be applied to the outer surface 276 to provide shielding for the electrical component 270.

FIG. 8 illustrates an exemplary chart of measured conductivity for different exemplary CBS conductors. The conductivity is measured in (ohms-cm)⁻¹. The chart shows conductivity for untreated CBS conductors 280, 282, 284 as compared to organometallic treated CBS conductors 290, 292, 294.

The chart shows conductivity measurements for a first untreated CBS conductor 280, which is a CNT tape, a second untreated CBS conductor 282, which is also a CNT tape, and a third untreated CBS conductor 284, which is a CNT yarn. Variations in the conductivity of the untreated CBS conductors 280, 282, 284 are observable, with the conductivity of the first untreated CBS conductor 280 being approximately 500 (ohms-cm)⁻¹, the conductivity of the second untreated CBS conductor 282 being approximately 200 (ohms-cm)⁻¹, and the conductivity of the third untreated CBS conductor 284 being approximately 50 (ohms-cm)⁻¹.

The chart shows conductivity measurements for a first organometallic CBS conductor 290, which is the first CBS conductor 280 after having an organometallic, in this embodiment being palladium glycolate, applied to the CBS network. The chart also shows a second organometallic CBS conductor 292, which is the second CBS conductor 282 after having an organometallic, in this embodiment being palladium glycolate, applied to the CBS network. The chart also shows a third organometallic CBS conductor 294, which is the third CBS conductor 284 after having an organometallic, in this embodiment being palladium glycolate, applied to the CBS network. The conductivity of the organometallic CBS conductors 290, 292, 294 is considerably higher than the corresponding untreated CBS conductors 280, 282, 284, respectively. The conductivity of the first organometallic CBS conductor 290 is approximately 1300 (ohms-cm)⁻¹, the conductivity of the second organometallic CBS conductor 292 is approximately 1100 (ohms-cm)⁻¹, and the conductivity of the third organometallic CBS conductor 294 is approximately 1500 (ohms-cm)⁻¹.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A cable comprising:
a jacket surrounding a core; and
a carbon-based substrate (CBS) conductor in the core, the CBS conductor comprising a CBS network and an organometallic filler, wherein the organometallic filler combines with the CBS network to form a composite conductor having a higher conductivity than the CBS network.

2. The cable of claim 1, wherein the CBS network comprises carbon nanotube (CNT) fibers, the organometallic fillers being disposed within the CNT fibers.

3. The cable of claim 1, wherein the organometallic fillers comprise at least one of palladium glycolate, glycolic acid, glyoxyllic acid or methanol.

4. The cable of claim 1, wherein the CBS network comprises one of a yarn, a sheet, and a tape.

5. The cable of claim 1, wherein the organometallic filler is applied to the CBS network as a solution that is decomposed under heat to create the composite conductor.

6. The cable of claim 1, wherein the CBS network is bathed in an organometallic bath to react the organometallic filler with the CBS network.

7. The cable of claim 1, wherein the organometallic filler is introduced as an organometallic bath having a solvent and organometallic particles, the solution being heated to remove the solvent from the composite conductor leaving reacted organometallic particles in the CBS network.

8. The cable of claim 1, wherein the CBS network and the organometallic fillers are densified to create the composite conductor.

9. The cable of claim 1, further comprising a plurality of the CBS conductors twisted along a length of the cable to form a central conductor of the cable.

10. The cable of claim 1, wherein the CBS conductor surrounds the core and provides EMI shielding for the core.

11. The cable of claim 1, wherein the cable comprises a coaxial cable having an insulator and a second CBS conductor in the core, the insulator surrounding the CBS conductor, the second CBS conductor surrounding the insulator, the jacket surrounding the second CBS conductor, the second CBS conductor providing EMI shielding for the other CBS conductor, which is configured to convey electrical signals between a first end and a second end of the cable.

12. A method for manufacturing a carbon-based substrate (CBS) conductor comprising:
providing a CBS network of CBS fibers forming a framework;
introducing an organometallic compound; and
reacting the CBS network with the organometallic compound to form a composite conductor.

13. The method of claim 12, wherein said introducing the organometallic compound includes immersing the CBS network in an organometallic bath.

14. The method of claim 12, wherein said introducing the organometallic compound includes immersing the CBS network in an organometallic bath having organometallic particles in a solvent.

15. The method of claim 14, wherein said reacting the CBS network with the organometallic compound includes heating the composite conductor to remove the solvent leaving behind the reacted organometallic particles.

16. The method of claim 12, further comprising annealing the composite conductor.

17. The method of claim 12, further comprising densifying the composite conductor by heating and cooling the composite conductor.

18. The method of claim 12, wherein the providing a CBS network comprises extracting CBS fibers from a CBS array to form the framework having a shape of one of a yarn, a tape or a sheet.

19. The method of claim 12, further comprising forming the composite conductor into a cable during a cable forming process.
